(19) United States
(12) Patent Application Publication
(10) Pub. No.: US 2016/0148404 A1
(43) Pub. Date: May 26, 2016

(54) Methods of Displaying Expense Allocated to Employees for a Plurality of Projects

(71) Applicant: Lexmark International, Inc., Lexington, KY (US)

(72) Inventors: Adam Ahne, Lexington, KY (US); William George Goff, III, Lexington, KY (US); Jason Todd McReynolds, Georgetown, KY (US)

(21) Appl. No.: 14/548,770

(22) Filed: Nov. 20, 2014

(51) Int. Cl. G06T 11/20

(52) U.S. Cl. CPC G06T 11/206

(57) ABSTRACT

A method of generating and displaying an animation of an organization's employees allocated to one or more of a plurality of projects is disclosed. The method includes generating a series of organization maps of the organization showing the organization over a period of time. The series includes a historic organization map and a projected organization map. The organization maps include nodes representing individual employees. For each node in each organization map, the color of the node is set to a first color if the node's employee is allocated to a first project, a second color if the node's employee is allocated to a second project, and to a third color if the node's employee is allocated to both the first project and the second project. The series of organization maps is displayed on a color monitor as an animation. Other methods are disclosed.

### BACKGROUND

1. Field of the Disclosure

The present disclosure relates generally to graphing the reporting structure of large organizations and more particularly to generating and displaying animations of projects as they flow through large organizations.

2. Description of the Related Art

Graphs of the reporting structure of organizations typically take the form of a tree, with the Chief Executive Officer (CEO) at the top of the chart, direct reports to the CEO in a row below the CEO, and lower ranking employees in progressively lower rows. However, such charts become cumbersome for larger organizations as the lower rows become progressively longer. Organizations have been mapped using a hyperbolic network mapping algorithm, with positions in the organization treated as nodes, and lines of authority treated as links. The resulting chart is less cumbersome for larger organizations than is the traditional row and column graph.

These graphs show the reporting structure at a fixed point in time. They do not show as the organization as it changes over time via an animation. They do not show the expense allocated to projects as the projects flow through the organization. Such animations may be very useful to the CEO, and other management, to help manage resource allocation. Understanding the flow of projects is difficult in large organization because of the large number of people involved and the number of management layers between the resource allocators and the employees doing the work. What is needed is a way to generate these animations for large organizations.

### SUMMARY

The invention, in one form thereof, is directed to a method of generating and displaying an animation of expense allocated to employees of an organization for a plurality of projects. The method includes generating a first map of the organization using a network mapping algorithm. The first map has a plurality of nodes and each node represents an employee and has an associated boss line that connects that node to that node's employee's boss. Each node has an attribute called project color.

For each node within the first map, determine if that node's employee is allocated to a first project during a first period and is not allocated to another project during the first period, and if so determined then set that node's project color to a first color. Determine if that node's employee is allocated to a second project during the first period and is not allocated to another project during the first period, and if so determined then set that node's project color to a second color. Determine if that node's employee is allocated to more than one project during the first period, and if so determined then set that node's project color to a third color. Set a color of that node, that node's boss line, or both that node and that node's boss line to that node's project color.

The method also includes generating a second map of the organization using the same network mapping algorithm. For each node within the second map, determine if that node's employee is allocated to a first project during a second period and is not allocated to another project during the second period, and if so determined then set that node's project color to the first color. Determine if that node's employee is allocated to a second project during the second period and is not allocated to another project during the second period, and if so determined then set that node's project color to the second color. Determine if that node's employee is allocated to more than one project during the second period, and if so determined then set that node's project color to the third color. Set a color of that node, that node's boss line, or both that node and that node's boss line to that node's project color.

The method also includes displaying on a color monitor an animation having the first map and the second map. Determining if an employee is allocated to a given project is based on project expense assigned to that employee.

The invention, in another form thereof, is directed to a method of generating and displaying an animation of an organization's employees allocated to one or more of a plurality of projects. The method includes generating a series of organization maps of the organization showing the organization over a period of time. The series includes a historic organization map and a projected organization map. The organization maps include nodes representing individual employees. For each node in each organization map, set the color of the node, a line connected to the node, or both the color of the node and a line connected to the node to a first color if the node's employee is allocated to a first project, a second color if the node's employee is allocated to a second project, and to a third color if the node's employee is allocated to both the first project and the second project. Display the series of organization maps on a color monitor as an animation. The number of nodes in the historic organization map is not the same as the number of nodes in the projected organization map.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a map of an organization generated using a network mapping algorithm.

FIGS. 2-5 are maps of an organization to be used in an animation.

FIGS. 6 and 7 are flowcharts of methods of generating and displaying animations of expense allocated to employees of an organization for a plurality of projects.

### DETAILED DESCRIPTION

In the following description, reference is made to the accompanying drawings where like numerals represent like elements. The embodiments are described in sufficient detail to enable those skilled in the art to practice the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

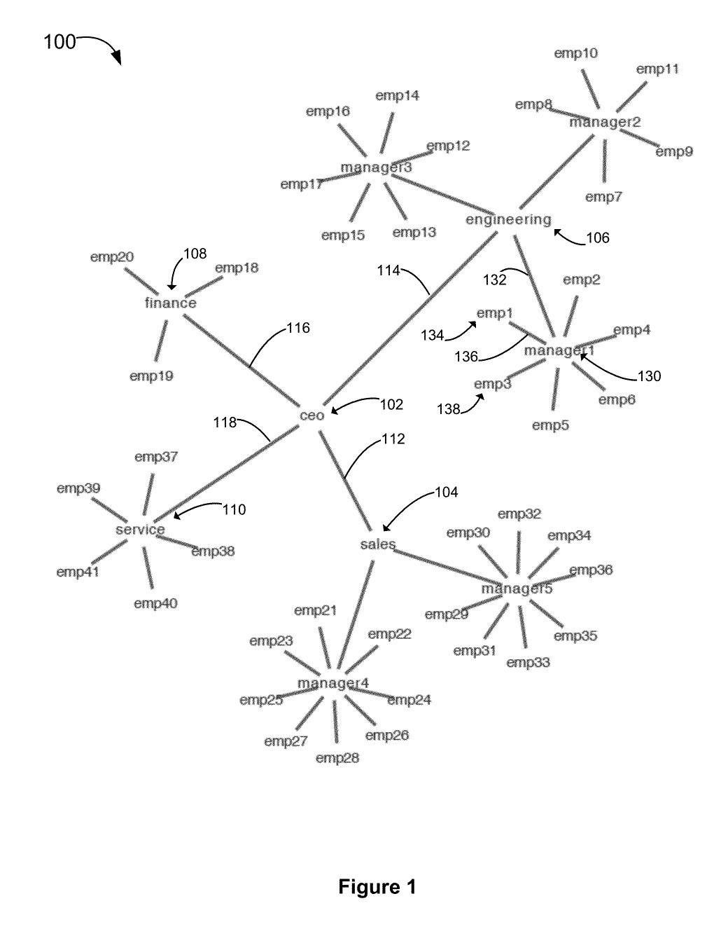

Referring now to the drawings and more particularly to FIG. 1, there is shown a map of an organization (org map) 100 that was generated using a network mapping algorithm. The org map 100 was generated using an algorithm known as a “circular” algorithm which generates spokes radiating around the perimeter of hubs. For mapping large organizations, for example organizations with more than one thousand employees, a circular algorithm is preferred over other algorithms, such as a hyperbolic algorithm, because a circular algorithm generates maps with a higher density of nodes. This makes viewing the whole org map easier while preserving the scale of the organization.

A CEO is the highest ranking employee, and all other employees report to the CEO. The CEO is represented by a CEO node 102. Managers for sales, engineering, finance, and service report directly to the CEO, and are represented by a sales manager node 104, engineering manager node 106, finance manager node 108, and service manager node 110. Each manager is represented by a node containing the department name. In this example, nodes contain the name of the department if the employee is a manager or contain the name of the employee if the employee is not a manager. Nodes may alternatively contain a geometric shape, e.g. circle, square, triangle, etc., with or without a name. For mapping large organizations, it is preferable to have nodes with a name and without a geometric shape to reduce clutter and improve readability of the org map. It is preferable to have each node represent only one employee, instead of collapsing reporting layers into a node, so that the flow of the project through the organization is not masked.

The sales manager node 104 has an associated boss line 112 connecting the sales manager node 104 to the CEO node 102. Similarly, boss lines 114-118 connect the engineering manager node 106, the finance manager node 108, and the service manager node 110 to the CEO node 102. Manager1 reports to the engineering manager, and manager1 node 130 is connected to engineering manager node 106 by boss line 132. Employee1, abbreviated as emp1, reports to manager1. Employee1 is represented by emp1 node 134, and is connected to manager1 node 130 by boss line 136. Employee2, employee3, employee4, employee5, and employee6 also report to manager1, and their nodes are arranged around a perimeter surrounding manager1 node 130. Other employees are similarly arranged in the org map 100. The data used to create org map 100 may conic from a human resources database.

This hub and spoke style of org map, where employee nodes are arranged around a perimeter surrounding their associated manager node, is an efficient method to display large organizations. Since some employees are located between their associated manager and the CEO node 102 (e.g. employee3 node 138 is closer to CEO node 102 than is manager1 node 130), the circular algorithm naturally pushes larger groups, such as the group connected to engineering manager node 106, further away from the CEO node 102 than smaller groups, such as the group connected to finance manager node 108. This creates a better view of the scale of a group relative to the entire organization than does a map generated by algorithms that do not put employees closer to the CEO than are their managers.

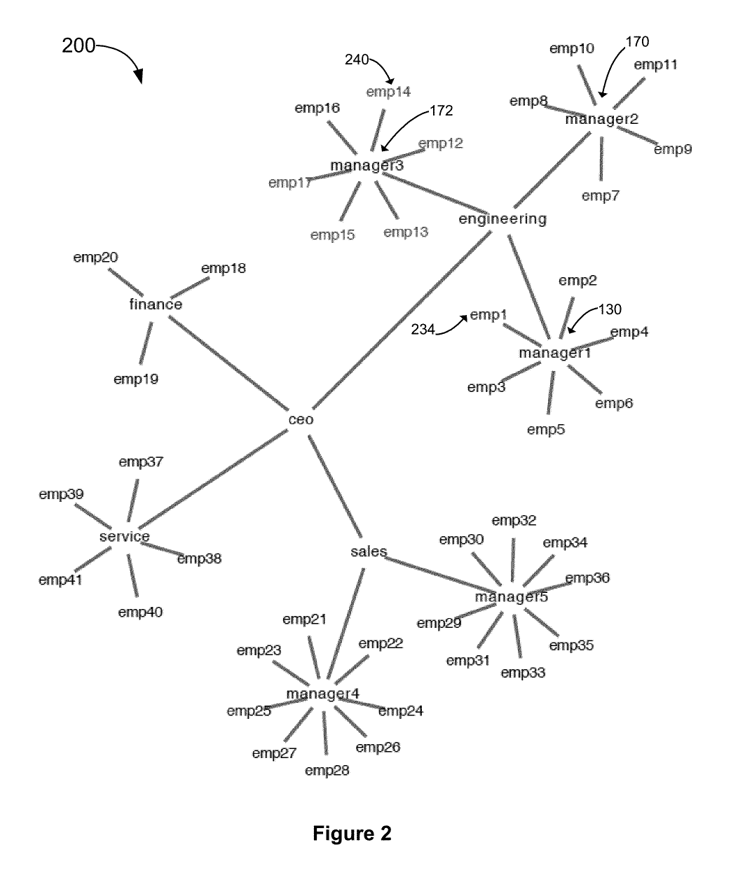

FIG. 2 shows an org map 200 of the same organization as is shown in FIG. 1 and was generated using the same network mapping algorithm. Org map 200 shows which employees are allocated to a first project and a second project during a period of time, e.g. during the first quarter of a year, and the color of the nodes correspond to the project the associated employee is allocated to.

Emp1 node 234 has an attribute called project color, and the text in emp1 node 234 is drawn in that color. In this example, employee1 is allocated to the first project, the project color of emp1 node 234 is blue, and the text in emp1 node 234 is drawn in blue. Emp14 node 240 also has an attribute called project color, and the text in emp14 node 240 is drawn in that color. In this example, employee14 is allocated to the second project, the project color of emp14 node 240 is red, and the text in emp14 note 240 is also red. Since employee1 is allocated to a different project than employee14, emp1 node 234 is a different color than emp14 node 24. The nodes of all the employees allocated to the first project are drawn in blue, the nodes of all employees allocated to the second project are drawn in red, and the nodes of all employees that are not allocated to either project are drawn in black.

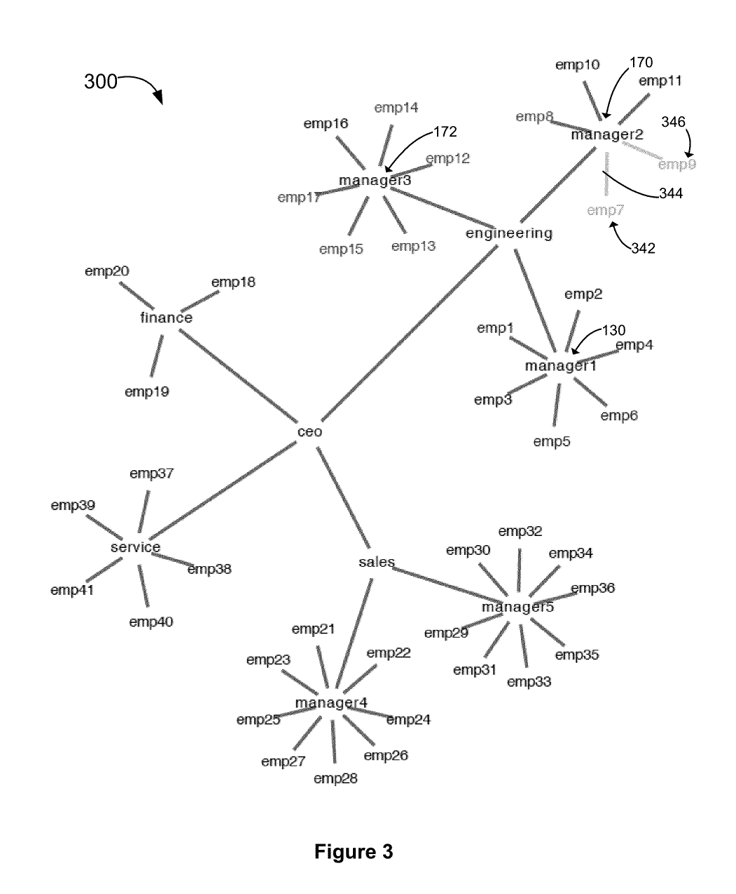

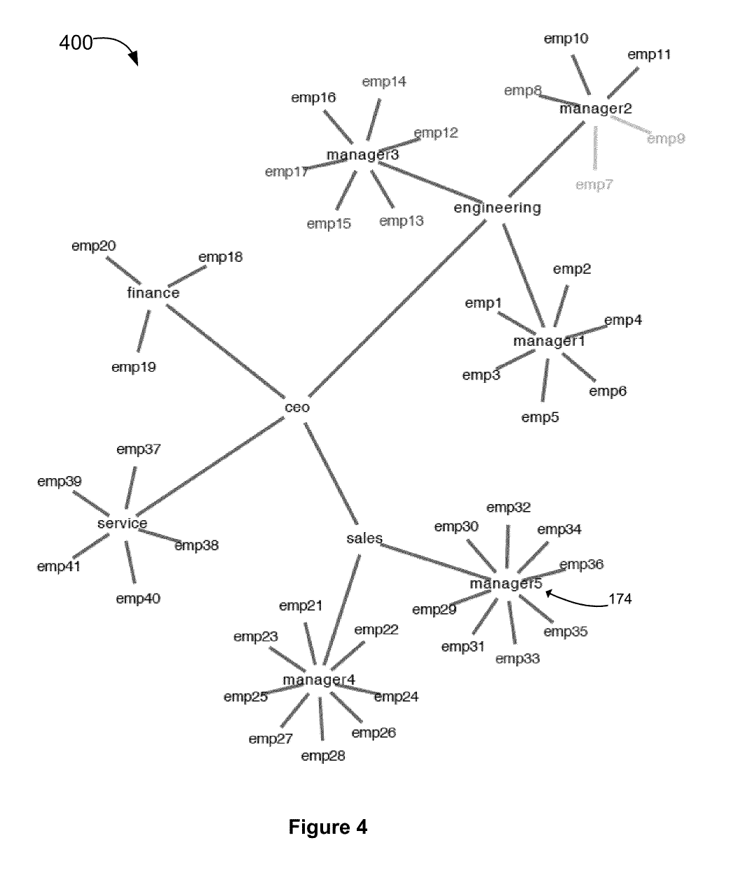

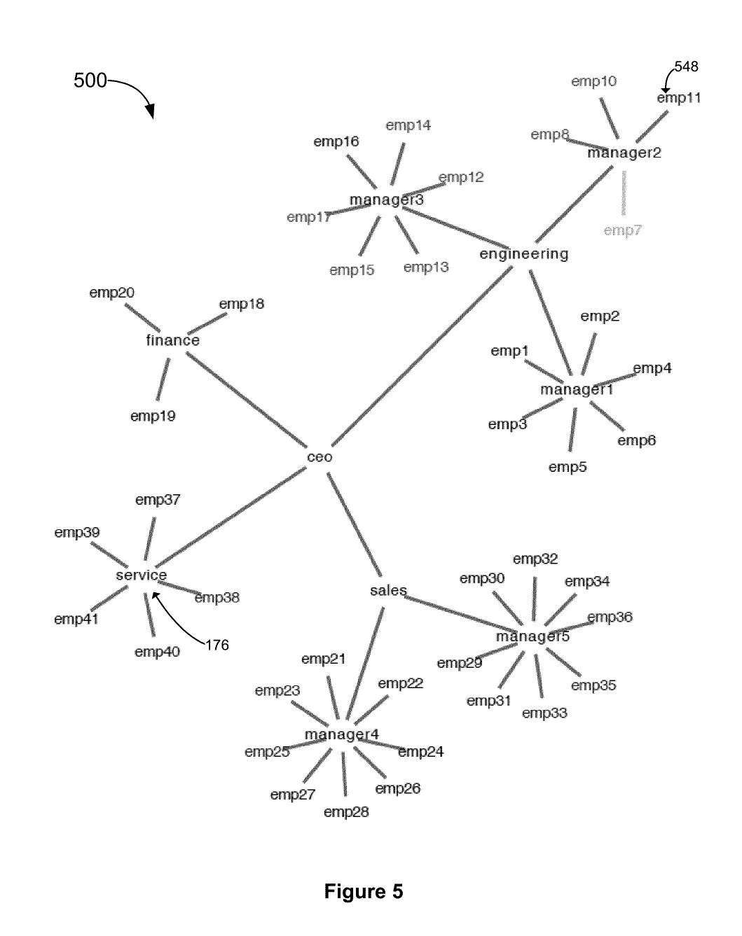

FIGS. 3-5 show an org maps of the same organization as FIG. 1 and were generated using the same network mapping algorithm to provide visual continuity. Org map 200, org map 300, org map 400, and org map 500 show project allocation during sequential quarters of a year.

During the second quarter, as shown in org map 300, employee7 was allocated to both the first project and the second project and thus emp7 node 342 project color is orange. Emp7 node 342 is drawn in orange as is that node's boss line 344. This highlights that employee7 is allocated to multiple projects and is potentially overburdened. Employee9 is also allocated to the first project and the second project, and thus emp9 node 346 is drawn in orange.

It is preferable to draw managers in the same color as employees that are not allocated to a project e.g. drawn in black. Many managers will have reporting employees that are allocated to different projects. If these manager's nodes were also colored orange it would distract from the highlighting provided by drawing the potentially overburdened employees in orange. If, in addition to managing employees, a manager directly works on a project then they may also be colored according to their project allocation.

By displaying an animation of org map 200, org map 300, org map 400, and org map 500, in that sequence, the flow of the expense allocated to the first project and the second project can be readily seen. In the first quarter (org map 200), the projects are allocated to separate departments in engineering (manager1 node 130 and manager2 node 170, manager3 node 172). In the second quarter (org map 300), the projects are still allocated to departments in engineering, and they are both allocated to some of the same employees in an engineering department (manager2 node 170). In the third quarter (org map 400), the first project entered a new phase and moved into a sales department (manager5 node 174). In the fourth quarter (org map 500), the first project entered another new phase and moved into a service department (service node 176). By studying this animation, the CEO may readily see the status of multiple projects, and may gain insight as to how projects move through the organization. This insight may inform decisions as to where to add or remove employees or how to stage the timing between projects. The animation may be displayed, for example, on a color monitor. In the animation, the nodes of employees allocated to multiple projects may blink to highlight the potentially overburdened employees.

Whether an employee is allocated to a project may be based on, for example, whether that employee's expense, e.g. salary, benefits, etc., is allocated to a project. This expense data may be accessed from a financial database. However, if, for example, org map 500 is generated during the third quarter, yet org map 500 shows a projection of the organization and projects for the fourth quarter, historical data will not exist to determine employee allocation. Projected data is generated to determine if an employee is allocated to a given project.

Projected data for a future quarter may be generated by polling managers and recording their estimates of employee allocations. Alternatively, projected data may be generated based on historic data of another project. For example, if during the service phase of the third project one service employee was allocated to the third project, projected data for the service phase of the first project would have one service employee allocated to the first project, as shown in org map 500.

Creating a projection of an organization may also include incorporating projected changes in the structure of the organization, such as when an employee retires. For example, if employee9 announced that they will retire at the end of the third quarter, their associated node will not be present in the fourth quarter org map 500. Projected project expense allocated to that employee will be allocated to an alternate employee, preferably in the same department, such as employee11 represented by emp11 node 548.

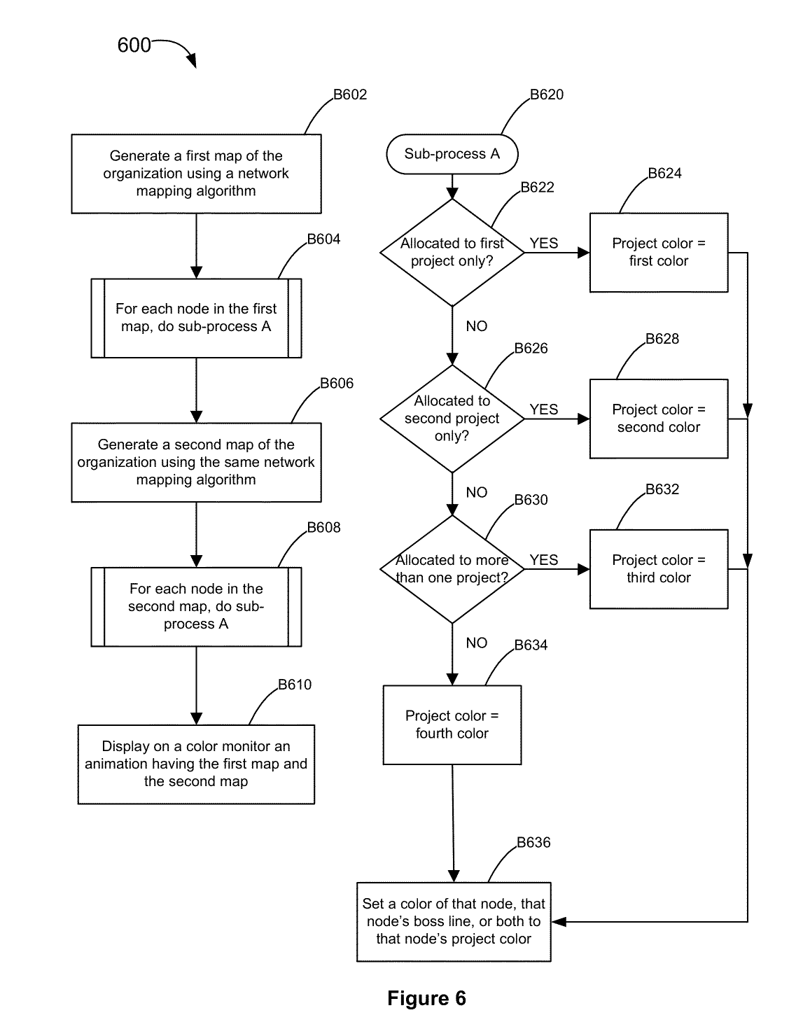

FIG. 6 shows an example embodiment of a method of generating and displaying an animation of expense allocated to employees of an organization for a plurality of projects according to one embodiment. Method 600 displays the animation on a color monitor.

At block B602, a first map of the organization is generated using a network mapping algorithm. The first map has a plurality of nodes and each node represents an employee. Each node also has an associated boss line that connects that node to that node's employee's boss. Each node has an attribute called project color, which will be used to set the color of that node and/or the color of that node's boss line.

At block B604, a sub-process A is performed for each node in the first map. Sub-process A begins at block B620. At block B622, it is determined if that node's employee is allocated to a first project during a first period and is not allocated to another project during the first period, and if so determined then at block B624 that node's project color is set to a first color e.g. blue. If not, then at block B626 it is determined if that node's employee is allocated to a second project during the first period and is not allocated to another project during the first period, and if so determined then at block B628 that node's project color is set to a second color e.g. red. If not, then at block 630 it is determined if that node's employee is allocated to more than one project during the first period, and if so determined then at block 632 that node's project color is set to a third color e.g. orange. If not, then at block 634 that node's project color is set to a fourth color e.g. black. At block B636, a color of that node, that node's boss line, or both that node and that node's boss line is set to that node's project color. Block B636 is the last block of the sub-process.

At block B606, a second map of the organization is generated using the same network mapping algorithm. Using the same algorithm improves the visual consistency between the first map and the second map which makes the resulting animation smoother.

At block B608, sub-process A is performed for each node in the second map. Sub-process A begins at block B620.

At block B610, an animation having the first map and the second map is displayed on a color monitor. Whether an employee is allocated to a given project is based on project expense assigned to that employee. Thus, the animation will show project expense flowing through the employees over a period of time. The animation may show what happened in the past. Alternatively, the animation may show projections of what may happen in the future and the employee allocation may be based on projected data. Such projected data may be generated based on historic data of a previous project.

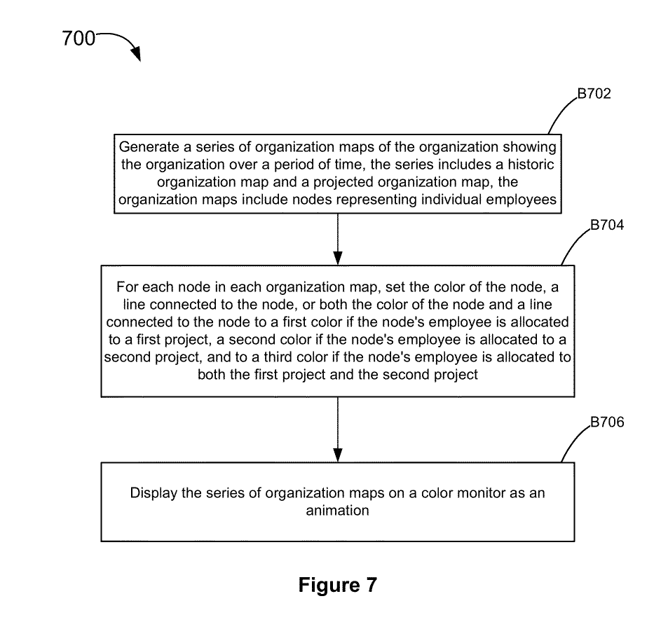

FIG. 7 shows an example embodiment of a method of generating and displaying an animation of an organization's employees allocated to one or more of a plurality of projects according to one embodiment. Method 700 displays the animation on a color monitor.

At block B702, a series of organization maps of the organization is generated showing the organization over a period of time. The series includes a historic organization map and a projected organization map. The organization maps include nodes representing individual employees.

At block 704, for each node in each organization map, the color of the node, a line connected to the node, or both the color of the node and a line connected to the node is set to a first color if the node's employee is allocated to a first project, a second color if the node's employee is allocated to a second project, and to a third color if the node's employee is allocated to both the first project and the second project Each node may be set to a fourth color, for example, if the node's employee is a manager or if the node's employee is not allocated to either the first project or the second project.

At block 706, the series of organization maps is displayed on a color monitor as an animation. The number of nodes in the historic organization map may be not the same as the number of nodes in the projected organization map. This may occur, for example, if employees are scheduled to leave the organization during the time depicted by the projected organization map. The allocation of employees to the first project in the projected organization map may be based on historic data of a third project. The allocation of employees to the second project may be based on allocation of expense in a finance database.

Generating and displaying an animation of multiple projects as they flow through an organization may be useful to understand the history of a project, such as, for example, when performing a post-mortem analysis of a project. The animation may also be useful to understand the possible future resource needs of existing projects, and to simulate potential future projects. For example, the animation may highlight bottlenecks that would be created if a new project is added. A CEO, or other resource managers, may generate an animation to evaluate the impact of integrating an acquired company into the existing organization.

The animations may be used to evaluate potential reorganizations of the organization and to understand the resulting impact to existing projects. Multiple animations may be generated to compare and contrast different potential reorganization plans.

Note that lines between nodes may be straight, curved, etc. A computer may be a personal computer, a cell phone, a tablet, etc. A monitor may be a stand-alone monitor, a cell phone screen, a tablet screen, etc. Contractors may be treated as employees when generating animations.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

What is claimed is:

1. A method of generating and displaying an animation of expense allocated to employees of an organization for a plurality of projects comprising:
(a) generating a first map of the organization using a network mapping algorithm, the first map has a plurality of nodes, each node represents an employee and has an associated boss line that connects that node to that node's employee's boss, each node has an attribute called project color,
(b) for each node within the first map:
determining if that node's employee is allocated to a first project during a first period and is not allocated to another project during the first period, and if so determined then setting that node's project color to a first color;
determining if that node's employee is allocated to a second project during the first period and is not allocated to another project during the first period, and if so determined then setting that node's project color to a second color;
determining if that node's employee is allocated to more than one project during the first period, and if so determined then setting that node's project color to a third color;
setting a color of that node, that node's boss line, or both that node and that node's boss line to that node's project color;
(c) generating a second map of the organization using the same network mapping algorithm;
(d) for each node within the second map:
determining if that node's employee is allocated to a first project during a second period and is not allocated to another project during the second period, and if so determined then setting that node's project color to the first color;
determining if that node's employee is allocated to a second project during the second period and is not allocated to another project during the second period, and if so determined then setting that node's project color to the second color,
determining if that node's employee is allocated to more than one project during the second period, and if so determined then setting that node's project color to the third color;
setting a color of that node, that node's boss line, or both that node and that node's boss line to that node's project color; and
(e) displaying on a color monitor an animation having the first map and the second map,
wherein determining if an employee is allocated to a given project in (b) is based on project expense assigned to that employee.

2. The method of claim 1, wherein determining if an employee is allocated to a given project in (b) is based on projected data.

3. The method of claim 2, wherein the projected data is generated based on historic data of a third project.

4. A method of generating and displaying an animation of an organization's employees allocated to one or more of a plurality of projects comprising:
generating a series of organization maps of the organization showing the organization over a period of time, the series includes a historic organization map and a projected organization map, the organization maps include nodes representing individual employees;
for each node in each organization map, setting the color of the node, a line connected to the node, or both the color of the node and a line connected to the node to a first color if the node's employee is allocated to a first project, a second color if the node's employee is allocated to a second project, and to a third color if the node's employee is allocated to both the first project and the second project; and
displaying the series of organization maps on a color monitor as an animation,
wherein the number of nodes in the historic organization map is not the same as the number of nodes in the projected organization map.

5. The method of claim 4, wherein the allocation of employees to the first project in the projected organization map is based on historic data of a third project.

6. The method of claim 4, wherein the allocation of employees to the second project is based on allocation of expense in a finance database.

7. The method of claim 4, wherein nodes are set to a fourth color if the node's employee is a manager or if the node's employee is not allocated to either the first project or the second project
